(19) United States
(12) Patent Application Publication
(10) Pub. No.: US 2023/0315500 A1
(43) Pub. Date: Oct. 5, 2023

(54) MANAGEMENT TASK METADATA MODEL AND COMPUTING SYSTEM SIMULATION MODEL

(71) Applicant: Hewlett-Packard Development Company, L.P., Spring, TX (US)

(72) Inventor: Christoph Graham, Spring, TX (US)

(73) Assignee: Hewlett-Packard Development Company, L.P., Spring, TX (US)

(21) Appl. No.: 18/043,898

(22) PCT Filed: Sep. 25, 2020
(86) PCT No.: PCT/US2020/052650

§ 371 Date: Mar. 2, 2023

(51) Int. Cl. G06F 9/455; G06F 9/48

(52) U.S. Cl. CPC G06F 9/455; G06F 9/4881

(57) ABSTRACT

A metadata model includes metadata of selected management tasks to be performed on components of a computing system. The metadata of each management task includes task requirements and historical task performance of the task. A simulation model for the computing system corresponds to the metadata model, and is determined by simulating the metadata model against characteristics of the computing system to generate simulation results.

### BACKGROUND

Enterprises and other organizations can often have tens, hundreds, thousands, and even more computers and other types of devices, including printing devices, scanning devices, network devices, and so on. Administrators or other users may be responsible for managing the devices for configuration, updating, monitoring, and other purposes. An administrator may schedule management tasks for later performance on the devices at a time when minimal usage of the devices is likely, such as overnight or during the weekend.

### BRIEF DESCRIPTION OF THE DRAWINGS

FIG. 1 is a diagram of an example architecture in which a metadata model can be simulated against characteristics of a computing system to generate a corresponding simulation model that can be displayed as a visualization model.

FIG. 2 is a diagram of an example metadata model and an example simulation model determined by simulating the metadata model against example characteristics of a computing system.

FIGS. 3 and 4 are flowcharts of an example method.

FIG. 5 is a diagram of an example computer-readable data storage medium.

### DETAILED DESCRIPTION

Management tasks can be performed on a computing system of devices, including physical and virtualized computers and other types of devices. A management task can be specific to a hardware or software component of a device, such as to update, patch, or install a software component, or configure or reconfigure a hardware or software component, and thus can update a state of the component. A software component may be an operating system, a device driver, an application program, and so on, and a management task can thus correspond to a set of configuration parameters, or an installable package, executable script, installable patch, or executable update for the software component. A hardware component may be a network, display, or memory controller, or another type of hardware component such as a storage device, etc., and a management task can correspond to a firmware update, a disk image, or a set of configuration parameters for the hardware component.

In a computing system with a large number of diverse devices that have different hardware components and that run different versions of different software components, an administrator may schedule performance of a set of management tasks without knowing in advance if the tasks can be successfully completed. A management task for a software component may fail to successfully complete if it pertains to a different version than that which is installed on a device, if it needs more hardware resources than the device has installed or available, and so on. A management task for a hardware component may similarly fail to successfully complete if it pertains to a different type, model, or version than that of the device.

An administrator may similarly schedule performance of a set of management tasks without knowing in advance how long the task performance will take. This means that the administrator may not have a sense for when to schedule task performance. For example, a management task that is completed in less time may be scheduled for overnight execution with minimal degradation to services that the computing system provides, whereas a task that takes longer to complete may be scheduled for execution during a holiday. Even if a management task is thought to be minor, the particulars of the computing system may result in task execution time being longer than expected.

A limited solution to these difficulties is to perform the management tasks on a small number of devices, so that the administrator can get a sense for whether successful task execution is likely to occur computing system-wide, and so that the administrator can extrapolate system-wide task performance time.

However, the selected devices on which the management tasks are performed may not be representative of the computing system as a whole. The administrator may thus develop false confidence that system-wide task performance will largely be successful, and/or wrongly extrapolate how long performing the management tasks will take on a system-wide basis.

Techniques described herein ameliorate these difficulties. Metadata of selected management tasks to be performed on the components of a computing system form a metadata model. The metadata model is simulated against characteristics of the computing system to generate simulation results, as a simulation model corresponding to the metadata model. The simulation results can indicate whether management task performance will likely be successful for a particular device or devices, as well as overall task performance time, in a way that takes into account the particularities of the system.

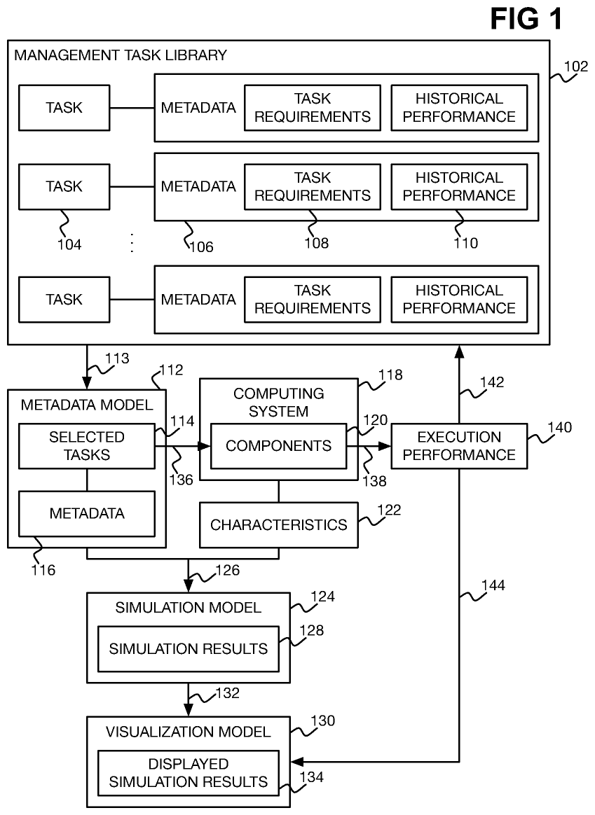

FIG. 1 shows an example architecture in which metadata model simulation occurs for corresponding simulation model generation. A management task library 102 can be constructed as including management tasks 104 that can be performed on different computing systems, such as different hardware and/or software components of different devices of the systems. A task 104 can be specified in a scripting language or in a domain-specific language, which is a programming language providing a higher level of abstraction specifically optimized for device management. Each task 104 has associated metadata 106. The metadata 106 of a task 104 can include task requirements 108 and historical task performance 110, as parts of the metadata 106. The library 102 may not be particular to any specific computing system, but rather form a domain or universe of available management tasks 104 that can be applied to various computing systems.

The task requirements 108 of the metadata 106 of a management task 104 can specify the conditions that have to be satisfied for successful execution performance of the task 104 against a corresponding computing system component. The task requirements 108 may include the target component type of the component in relation to which the task 104 is applicable.

For example, the task requirements 108 may specify a particular version of a software component, or a particular version or model of a hardware component. The task requirements 108 may include a target operating environment in relation to which the task 104 is applicable. For example, the task requirements 108 may specify a particular version and a particular kind of operating system as to a software component-oriented task 104, or a particular chipset or other hardware architecture as to a hardware component-oriented task.

The task requirements 108 of the metadata 106 of a management task 104 may include resource requirements that have to be satisfied for successful performance of the task 104. For example, the task requirements 108 may specify that a particular patch, update, or new release of or for a software component to which a corresponding task 104 relates needs a certain amount of available storage space for successful installation, and a certain amount of total system memory for successful execution. The task requirements 108 may include dependencies that have to be satisfied for successful performance of the task. For example, the task requirements 108 may specify that a particular version of another software component has to be installed prior to installation of a particular patch, update, or new release of or for a software component to which the task 104 relates.

The historical performance 110 of the metadata 106 of a management task 104 can specify how long execution of the task 104 actually took on different computing systems. The execution performance of the task 104 may be initially measured under lab or test conditions, in which test computing systems are set up for assessing such actual execution performance. Thereafter, as the task 104 is executed on deployed real-world computing systems, the actual task execution performance on those systems can be measured to update the historical performance 110 for the task 104. Therefore, over time the historical performance 110 can become more accurate for systems of diverse types. However, even before performance on a real-world system, actual historical performance 110 is available to at least some degree.

A metadata model 112 can be determined (113), and includes metadata 116 of selected management tasks 114 to be performed on components 120 of a computing system 118, such as at a designated time of day.

An administrator may select the tasks 114 from the library 102 of management tasks 104, and may designate the time of day at which the selected tasks 114 are to be performed. Each task 114 thus corresponds to one of the tasks 104, and the metadata 116 of the task 114 is the metadata 106 of the corresponding task 104, including the task requirements 108 and historical performance 110 of the task 104. The designated time of day may be a specific day of the week, or more particularly a specific actual date.

The computing system 118 is an actual deployed real-world computing system having components 120 that can reside at one or over multiple devices, such as computers and other types of devices. The system 118 can include all or a subset of the devices of an enterprise or other organization, for instance. The components 120 can include software components as well as hardware components. The system 118 has characteristics 122. The characteristics 122 can define the operating environment of the system 118 — such as the operating system and/or hardware environment of each device of the system 118 — as well as the component type of each component 120 of the system 118, including the particular version, model, or other identifying type information of the component 120.

The characteristics 122 of the computing system 118 can further define system performance at different times of day, and which components 120 are running at the different times of day. For example, the characteristics 122 may include average processor utilization over a 24-hour period, and average network congestion over a 24-hour period. A software component 120 may be considered as running at a given time if it is being executed at that time, or if its processor utilization is more than a threshold at that time (as opposed to just being open and running in the background without actively using any processing resources). A hardware component 120 may similarly be considered as running at a given time if its utilization is greater than a threshold at that time.

The metadata model 112 can be simulated (126) against the characteristics 122 of the computing system 118 to determine a simulation model 124 for the system 118 that corresponds to the metadata model 112. Rather than or prior to the selected tasks 114 being performed on the components 120 of the system 118, such performance can thus first be simulated. The simulation model 124 includes simulation results 128 generated by the simulation. The simulation model 124 can specify, as part of the results 128, whether simulated performance of the selected management tasks 114 on the components 120 of the system 118 was successful, such as on a per-task 114 basis and/or at the designated time of day as specified by the model 124. The simulation model 124 can further specify, as part of the results 128, a completion time of the simulated performance (i.e., how long it will likely take to perform each and/or all of the tasks 114 on the components 120).

Simulating the metadata model 112 against the characteristics 122 of the computing system 118 can simulate performance of the selected management tasks 114 on the components 120 of the system 118 at the designated time of day in such a way that takes into account the system performance and the running components of the system 120 at this time of day.

That is, the performance simulation considers not just the selected management tasks 114 as to the components 120 of the system 118, but the likely system performance of the system 118 and which components 120 are likely to be actually running at the time of day at which the tasks 114 are to be performed. As such, the simulation model 124 can provide more accurate simulation results 128 than if this information were not taken into account. An example manner by which simulation can be performed is described later in the detailed description.

The simulation results 128 can be displayed (132), as displayed simulation results 134, to in effect determine a visualization model 130 for the computing system 118 corresponding to the simulation model 124 and that includes the displayed simulation results 134. The visualization model 130 can show which selected management tasks 114 are likely to successfully complete if executed on respective components 120 of the system 118 and which are likely to be unsuccessful. The visualization model 130 can show the total expected completion time of the selected tasks 114, as well as the expected completion time of each task 114. The visualization model 130 may contrast the overall and per-task 114 expected completion time with respective actual historical completion time on computing systems similar to the system 118, based on the historical task performance provided in the metadata 116 of the selected tasks 114.

In response to the simulation model 124 indicating successful metadata model 112 simulation against the characteristics 122 of the computing system 118, the selected management tasks 114 may be actually performed (136) on the components 120 of the system 118, such as at the designated time of day specified by the simulation model 124. An administrator may make the final decision as to whether the selected tasks 114 are to be performed on the components 120, or the tasks 114 may be automatically scheduled for performance at the designated time of day if simulation was successful. The execution performance 140 of the selected tasks 114 on the components 120 may be measured (138) as the tasks 114 are performed, and the historical performance 110 for the corresponding tasks 104 accordingly updated (142) within the library 102. This feedback loop can thus improve accuracy in subsequent task simulation.

The actual execution performance 140 can also be displayed (144) to form part of the visualization model 130. The visualization model 130 can show which selected management tasks 114 actually completed successfully and which did not. For the tasks 114 that did not successfully complete, the visualization model 130 may provide information as to why execution was not successful. The visualization model 130 can show the actual completion time of the selected tasks 114 that were successfully performed, as well as the actual completion time of each such task 114. The visualization model 130 may contrast the overall and per-task 114 actual completion time with the corresponding expected completion time per the simulation results 128, and/or with respective historical completion time on computing systems similar to the system 118. Similarly, the management tasks 114 that failed to complete successfully may be categorized by type and/or over the type of computing systems (including the system 118) on which they failed to complete.

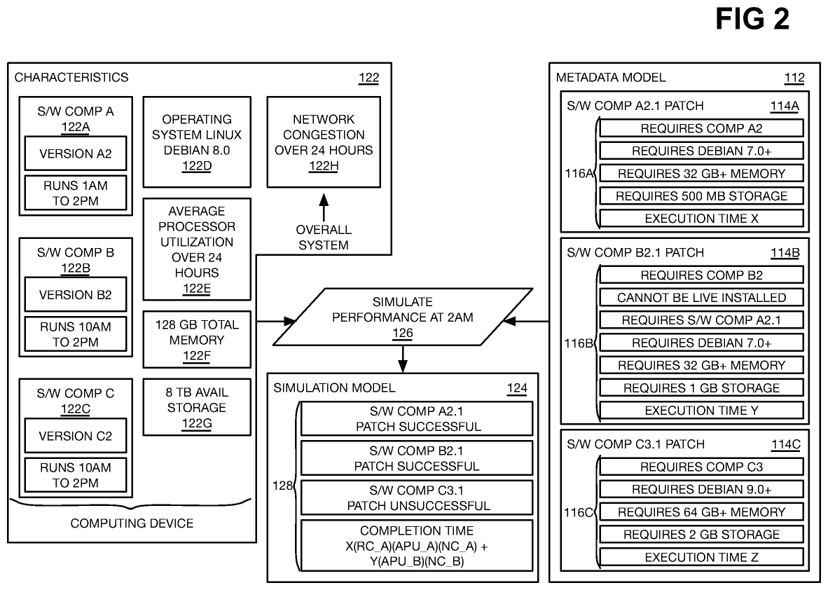

FIG. 2 shows example simulation of a specific example metadata model 112 against specific example computing system characteristics 122 to determine a corresponding example simulation model 124. The characteristics 122 include characteristics 122A, 122B, and 122C for respective software components A, B, and C installed on a specific computing device of the computing system. The software components A, B, and C may be application programs, device drivers, or other types of software components. The characteristics 122A, 122B, and 112C specify that their corresponding software components A, B, and C are specifically versions A2, B2, and C2, respectively.

The characteristics 122A, 122B, and 122C further specify that their corresponding software components A, B, and C are usually run between 1 AM and 2 PM, between 10 AM and 2 PM, and between 10 AM and 2 PM, respectively.

The characteristics 122 include characteristics 122D, 122E, 122F, and 122G as to the operating environment of the device. The characteristic 122D specifies that the device is running version 8.0 of the DEBIAN distribution of the LINUX operating system (i.e., the DEBIAN LINUX operating system). The characteristic 122E specifies the average processor utilization of the device over a 24-hour period, such as the average processor utilization within each 15-minute period of the 24-hour period. The characteristics 122F and 122G respectively specify that the device has 128 gigabytes (GB) of total system memory and 8 terabytes (TB) of available storage device space. The characteristics 122 further include characteristic 122H as to the overall computing system as a whole, specifically the average network congestion within the system over a 24-hour period, such as within each 15-minute of the 24-hour period.

The metadata model 112 includes metadata 116A, 116B, and 116C for respective management tasks 114A, 114B, and 114C. The task 114A is to install a patch for the software component A to update the component A to version 2.1. The metadata 116A specifies that the requirements for successful completion of the task 114A include that version 2 of the component A is already installed, and that the device is running at least version 7.0 of the DEBIAN LINUX operating system. The requirements also include that the device have at least 32 GB of memory and at least 500 megabytes (MB) of available storage space. The metadata 116A specifies that the historical task performance of the task 114A is that comparable devices have actually executed the task 114A in time X, which may be measured in seconds, minutes and second, and so on.

The management task 114B is to install a patch for the software component B to update the component B to version 2.1. The metadata 116B specifies that the requirements for successful completion of the task 114B include that version 2 of the component B is already installed, and that the device is running at least version 7.0 of the DEBIAN LINUX operating system. The requirements include that the patch cannot be live installed (viz., the component B cannot be actively running at time of installation). The requirements include the dependency that the component A first be updated to version 2.1. The requirements also include that the device have at least 32 GB of memory and at least 1 TB of available storage space. The metadata 116B specifies that the historical task performance of the task 114B is that comparable devices have actually executed the task 114B in time Y.

The management task 114C is to install a patch for the software component C to update the component C to version 3.1. The metadata 116C specifies that the requirements for successful completion of the task 114C include that version 3 of the component C is already installed, and that the device is running at least version 9.0 of the DEBIAN LINUX operating system. The requirements also include that the device have at least 64 GB of memory and at least 2 GB of available storage space. The metadata 116C specifies that the historical task performance of the task 114C is that comparable devices have actually executed the task 114A in time Z.

In the example of FIG. 2, the metadata model 112 is simulated (122) against the computing system characteristics 122 to determine the simulation model 124, by simulating actual performance of the management tasks 114A, 114B, and 114C at 2 AM on their respective software components A, B, and C of the computing device in question. An example of how such simulation may be performed is as follows. First, whether the tasks 114A, 114B, and 114C can likely be successfully performed on their respective components A, B, and C may be determined by analyzing the metadata 116A, 116B, and 116C against the characteristics 122.

Specifically, the management task 114A can likely be successfully completed because, per the characteristics 122, the software component A on the device is version A2, which is the minimum version specified by the metadata 116A for the task 114A. The task 114A can likely be successfully completed because, per the characteristics 122, the installed operating system is version 8.0 of the DEBIAN LINUX operating system, which is more recent than the minimum version specified by the metadata 116A. The task 114A can also likely be successfully completed because, per the characteristics 122, the total system memory and the available storage space are greater than the minimum amounts specified by the metadata 116A.

Likewise, the management task 114B can likely be successfully completed because, per the characteristics 122, the versions of the software component B and the operating system installed on the device are respectively equal to and greater than the minimum versions specified by the metadata 116B for the task 114B. The task 114B can likely be successfully completed because, per the characteristics 122, the component B will likely not be running at the time of task performance, in satisfaction of the patch of the task 114B not being able to be live installed as specified by the metadata 116B. The task 114B can also likely be successfully completed because, per the characteristics 122, the total system memory and the available storage space are greater than the minimum amounts specified by the metadata 116B.

In comparison to the tasks 114A and 114B, the management task 114C is unlikely to be successfully completed. This is because, per the characteristics 122, the versions of the software component B and the DEBIAN LINUX operating system installed on the device are older than the minimum versions specified by the metadata 116C for the task 114C. The task 114C is thus unlikely to be successfully completed even though, per the characteristics 122, the total system memory and the available storage space are greater than the minimum amounts specified by the metadata 116C.

Whether a management task is likely to successfully complete can be performed in other ways as well. Specific configuration values of system properties that may be changed can be inspected to determine whether changing them will counteract other properties in a prohibited way, will produce deleterious side effects, and so on. Likewise, whether current access rights interfere or whether the user can interfere with a proposed change can be assessed. The evaluation in this respect can be considered in the context of a multi-stage management task over each stage (e.g., each change) of the tasks.

Simulating actual task performance on the components of the computing device then include, second, determining for each of the management tasks 114A and 114B that can likely be successfully executed, the expected task completion time from the corresponding historical task performance time. Such expected task completion time determination may take into account whether the corresponding software component A or B will likely be running during task execution, and may also take into account the average device processor utilization and the average system network congestion at that time. The overall task completion time for both tasks 114A and 114B may then be determined by taking into account any dependencies between the tasks 114A and 114B.

Specifically, the expected task completion time of the management task 114A on the software component A of the device can be calculated as the historical execution time X specified by the metadata 116A for the task, multiplied by three weights RC_A, APU_A, and NC_A. The weight RC_A may be a weight at a defined value greater than one to take into account the longer task execution time that may result due to the component A likely actively running on the device at the simulated time, per the characteristics 122. The weight APU_A may be a weight corresponding to the average processor utilization of the device at the simulated time of 2 AM, per the characteristics 122, to increase the expected task completion time during times of high utilization. The weight NC_A may likewise be a weight corresponding to the average network congestion of the overall system at the simulated time, per the characteristics 122, to increase the expected task completion time during times of high congestion.

Similarly, the expected task completion time of the management task 114B on the software component B of the device can be calculated as the historical execution time Y specified by the metadata 116B for the task, multiplied by two weights APU_B and NC_B. Unlike for the task 114A, there is no weight to take into account longer execution time due to the component B actively running on the device at the simulated time of 2 AM, since per the characteristics 122, the component B will likely not be actively running during this time. The weight APU_B may be a weight corresponding to the average processor utilization of the device at the simulated time, per the characteristics 122, to increase the expected task completion time during times of high utilization. The weight NC_B may be a weight corresponding to the average network congestion of the overall system at the simulated time, per the characteristics 122, to increase the expected task completion time during times of high congestion.

The overall expected task completion time for completing both tasks 114A and 114B may be determined by adding together the individual task component times X(RC_A)(APU_A)(NC_A) and Y(APU_B)(NC_B) for the tasks 114A and 114B, respectively. The tasks 114A and 114B cannot be concurrently performed: the task 114A has to be performed before the task 114B because, per the metadata 116B, a dependency of the task 114B is that the component A first has to be updated to version 2.1 (e.g., by performing the task 114A). Therefore, the individual task component times are added to determine the overall task completion time, rather than determining the overall task completion time as the maximum of the two individual task completion times if the tasks 114A and 114B were instead able to be concurrently performed.

The resulting simulation model 124 corresponding to the metadata model 112 thus includes simulation results 128 that indicate that the tasks 114A and 114B for installing the patches for the software components A and B, respectively, to corresponding versions 2.1 are likely to succeed. The simulation results 128 indicate that the task 114C for installing the patch for the software component C to version 3.1 is unlikely to succeed. The simulation results 1228 further indicate the individual and overall expected task completion times when performing the tasks 114A and 114B on their respective components A and B of the computing device in question.

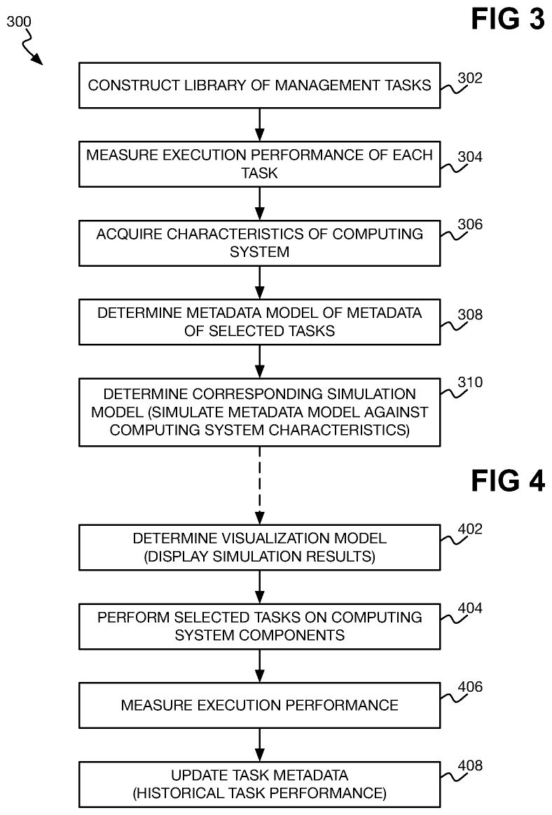

FIGS. 3 and 4 show an example method 300. The method 300 can be performed partially or completely by a processor. In this respect, the method 300 can be partially or completely implemented as program code stored on a non-transitory computer-readable data storage medium and executed by the processor. The method 300 may include just the parts depicted in FIG. 3, or the parts depicted in both FIGS. 3 and 4.

Referring to FIG. 3, the method 300 can include constructing a library of management tasks (302). Each management task defines task requirements as a part of metadata of the task. For instance, a simulation software tool may permit an administrator or other user to specify tasks, including their task requirements. The method 300 can include measuring execution performance of each management task to generate historical task performance as an additional part of the metadata of the task (304). For instance, the management tasks may be performed on test computing systems to collect such task execution performance to include within the library.

The method 300 can include acquiring characteristics of a computing system having components (306), against which selected management tasks are to be performed. An administrator may manually input the characteristics, or a software agent (e.g., program code) running on the computing device may be executed to collect the characteristics, for instance. The method 300 includes determining a metadata model of the metadata of selected management tasks to be performed on the components (308), and determining a simulation model for the computing system and corresponding to the metadata model (310). An administrator may specify the metadata model by selecting components from the constructed library, and a simulation software tool may then simulate the metadata model against the characteristics to generate simulation results of the simulation model.

Referring to FIG. 4, the method 300 can also include determining a visualization model corresponding to the simulation model (402), by displaying the simulation results. The method 300 may include, in response to the simulation model indicating successful metadata model simulation against the characteristics, performing the selected management tasks on the components (404). The method 300 may include measuring execution performance of the selected management tasks on the components (406), and correspondingly updating the historical task performance of each selected task as the additional part of its metadata within the library (408).

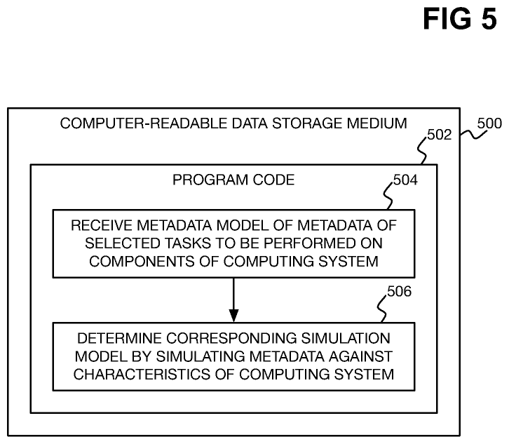

FIG. 5 shows an example non-transitory computer-readable data storage medium 500 storing program code 502 executable by a processor to perform processing. The processing includes receive a metadata model of metadata of selected management tasks to be performed on components of a computing system (504). The metadata of each management task includes task requirements and historical task performance of the task. The processing includes determine a simulation model for the computing system and corresponding to the metadata model (506), by simulating the metadata model against characteristics of the computing system to generate simulation results.

Techniques have been described for simulating performance of management tasks on a computing system. An administrator can thus assess whether execution of the tasks is likely to be successful before actually scheduling performance of the tasks. An administrator can also learn how long execution of the tasks will take, which can aid the administrator in identifying an appropriate time at which to schedule performance of the tasks.

We claim:

1. A method comprising:
constructing a library of management tasks, each management task defining task requirements as a part of metadata of the task;
measuring execution performance of each management task to generate historical task performance as an additional part of the metadata of the task;
acquiring characteristics of a computing system having a plurality of components;
determining a metadata model of the metadata of selected management tasks to be performed on the components of the computing system; and
determining a simulation model for the computing system and corresponding to the metadata model, by simulating the metadata model against the characteristics of the computing system to generate simulation results.

2. The method of claim 1, further comprising:
determining a visualization model for the computing system and corresponding to the simulation model, by displaying the simulation results.

3. The method of claim 1, further comprising:
in response to the simulation model indicating successful metadata model simulation against the characteristics of the computing system, performing the selected management tasks on the components of the computing system.

4. The method of claim 3, further comprising:
measuring execution performance of the selected management tasks on the components of the computing system; and
updating the historical task performance of each selected management task as the additional part of the metadata of the task within the library.

5. The method of claim 1, wherein the management tasks each correspond to an installable package, executable script, installable patch, or executable update, and/or update a state of a corresponding component.

6. The method of claim 1, wherein the task requirements of each management task specify conditions that have to be satisfied for successful execution performance of the task against a computing system component.

7. The method of claim 1, wherein the task requirements of each management task comprise a target component type and a target operating environment in relation to which the management task is applicable, and resource requirements and dependencies that have to be satisfied for successful performance of the management task.

8. The method of claim 1, wherein the characteristics of the computing system define an operating environment of the computing system and a component type of each component of the computing system.

9. The method of claim 1, wherein the characteristics of the computing system define system performance at different times of day and running components at the different times of day,
and wherein the simulation model further specifies a time of day at which the selected management tasks are to be performed on the components of the computing system.

10. The method of claim 9, wherein simulating the metadata model against the characteristics of the computing system comprises simulating performance of the selected management tasks on the components of the computing system at the time of day, taking into account the system performance and the running components of the computing system at the time of day.

11. The method of claim 9, wherein the simulation model specifies whether simulated performance of the selected management tasks on the components of the computing system at the time of day was successful and a completion time of the simulated performance.

12. A non-transitory computer-readable data storage medium storing program code executable by a processor to:
receive a metadata model of metadata of selected management tasks to be performed on components of a computing system, the metadata of each management task comprising task requirements and historical task performance of the task; and
determine a simulation model for the computing system and corresponding to the metadata model, by simulating the metadata model against characteristics of the computing system to generate simulation results.

13. The non-transitory computer-readable data storage medium of claim 12, wherein the program code is executable by a processor to further:
in response to the simulation model indicating successful metadata model simulation against the characteristics of the computing system, schedule performance of the selected management tasks on the components of the computing system at a time of day specified by the simulation model.

14. The non-transitory computer-readable data storage medium of claim 12, wherein the characteristics of the computing system define system performance at different times of day and running components at the different times of day, and the simulation model further specifies a time of day at which the selected management tasks are to be performed on the components of the computing system,
and wherein simulation of the metadata model against the characteristics of the computing system comprises simulation of performance of the selected management tasks on the components of the computing system at the time of day, taking into account the system performance and the running components of the computing system at the time of day.

15. The non-transitory computer-readable data storage medium of claim 14, wherein the simulation model specifies whether simulated performance of the selected management tasks on the components of the computing system at the time of day was successful and a completion time of the simulated performance.
